(19) United States
(12) Patent Application Publication
(10) Pub. No.: US 2019/0311412 A1
(43) Pub. Date: Oct. 10, 2019

(54) Customized Pricing for Digital and Non-Digital Publications

(71) Applicant: Chandra Shukla, Ann Arbor, MI (US)

(72) Inventor: Chandra Shukla, Ann Arbor, MI (US)

(21) Appl. No.: 15/911,166

(22) Filed: Mar. 4, 2018

(51) Int. Cl. G06Q 30/06; G06Q 30/02

(52) U.S. Cl. CPC G06Q 30/0621; G06Q 30/0249; G06Q 30/0255

(57) ABSTRACT

A new, unique and improved business model where customer chooses the price he wants to pay for any of the digital/non digital published material or products mentioned. The product company decides the fraction and places the advertisement to be placed on the books depending on the will of user he want to pay for a specific material, the customer gets the products at her chosen price and it contains advertisements embedded inside the digital contents.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The invention is related to an effective business model, where users will decide what price they want to pay for a book or digital publications and based on the same they will get the content. This business model will benefit all the participants Authors, Customers, Publishers and Advertising Companies.

### Description of the Related Art

Indeed, humans have held a special appreciation for books and other written works for thousands of years, and continue to do so today. In today's information society, people have access to a vast universe of electronic works, including electronic books, articles, news stories, and countless other electronic publications containing combinations of text, charts, images, photos, etc. People also continue to access a broad variety of printed works in more traditional paper form by going to libraries, bookstores, and newsstands, or by subscribing for home or office delivery of newspapers and periodicals. As the number of sources of written works has proliferated, however, and the means for acquiring those works has increased, people have found it more and more difficult to monitor and consume all of the sources of information that interest them. Pricing is another factor which restricts users to buy certain books(or any other digital/non digital published content) because of the cost of book even with discount if applicable.

Conventionally, user pays the price for the book which is written on it. However under the proposed model, users will decide what price they want to pay for the book and other digital publications and based on the same, they will get the content.

However, to Applicant's knowledge, none of these prior art methods have been found to be completely suitable to meet these needs and are cumbersome. Thus, there is a need in the prior art to beneficial and effective model that will be favorable for everyone involved in the channel. The present invention provides such a model and the overall combination of these features is nowhere disclosed in the prior art cited above which appears to be representative of the general art in this area although it is not intended to be an non-inclusive listing of pertinent prior art patents.

### SUMMARY

in light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

According to a first embodiment the present invention is business model, users will decide what price they want to pay for the book and other digital/non-digital publications(including but not limited to books, market research report, academic/nonacademic research papers etc.) and based on the same, they will get the content.

Embodiments of the invention relates to, the price selected by the users, and based of which contextual advertisement will be inserted inside the book or paper (usually but not necessarily in the same fraction as the price paid) and will give it to the user at the selected price.

Another embodiment of the invention is, a unique business model that will benefit all the participants Authors, Customers, Publishers and Advertising Companies.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Before explaining the invention in detail, it is to be understood that the invention is not limited in its application to the detail of application mentioned it is capable of other embodiments and of being practiced or carried out in various ways. It is also to be understood that the phraseology or terminology employed is for the purpose of description only and not of limitation.

The novelty of the present invention, a business process, is that currently publishers decide the price of the book or contents while users have limited options on the price decision. In this business model, users will decide what price they want to pay for the book and other digital/non digital publications and based on the same, they will get the content.

The business model operates in a way that user will be shown the digital content (Book/papers). And users will be asked the price which they are willing to pay. For example, if a book is sold for USD 19, our users can choose any price they want to pay for the book between 0 to 19 USD. Based on the price selected by the users, there will be insertion of contextual advertisement inside the book or paper (usually but not necessarily in the same fraction as the price paid) and will be given to the user at the selected price.

This way, the users will get the content at the price selected by the user. While the authors will get the same amount, they would have gotten otherwise. The advertising companies will be charged for the rest of the money. In case if more/excess value (or money) is generated from the entire process, the revenue sharing will be discussed accordingly

One of the numerous advantages of the present invention is the benefit this business model offers to all the participants i.e. Authors, Customers, Publishers and Advertising Companies.

The business model will be fruitful for all the parties engaged in the model such as authors will see more sales as the customer base will increase. Because there are lot of people who can't afford the content due to high price. Thus, non-customers will become costumers. And increasing sales will also generate more revenue to the publishers. Advertisers will get a suitable market place to show their advertisement.

How advertising will be posted:
For digital books like Kindle where the content is mostly on the cloud, there will be dynamic advertising contents which might change based on the user behaviors, timing and other characteristics. While in the digital contents where there is pdf or any other format of the book permanently, the plan is to place the contextual advertisements permanently embedded on the page. For the newspaper, there will be placement of the advertisements based on daily changing time and context. The same will be applicable on the academic publishing as well.
For the paper-based publishing, there will be placement of the advertisements permanently based on the geography of the distribution of the book. For example, when there is need to distribute the foreign author book in Indian subcontinent, there will be advertisements relevant to that region only.
Once a person has chosen the fraction of advertisement, he will always have an option of upgrading to the higher version of the content. For example, if a person chooses to have 50% advertisement in the book and realizes that it is not good for him, he can always ask for reducing the advertisement fraction at any stage. However, if somebody has bought the 0% advertisement content, it will not be possible for him to go for increasing advertisement. This restriction applies to the area where the content is fixed for example in a book. However in the areas where content is changing continuously, the users will have flexibility of changing the fraction of advertise at any point of time. Or indirectly we can say that user can change their willingness to pay any time in the case discussed later.
Based on user convenience and budget, users can choose the fraction of advertisement

Parties Impacted/Benefited by the New and Proposed Business Model
These are some of the business domains which will be directly impacted/benefitted by the new and proposed business model:
Ebooks, kindle books, Market Research Report, News Papers, News letters, Scientific Publishing including but not limited to peer reviewed journals, all the academic and non academic books available in the market. Libraries can have access to more quality content with in their budget so they will have access to more research thus will benefit faculties and students indirectly.

The new and proposed business model can change the revenue stream of several industries existing in the market. The following are some of the names which can be our potential customer of the patent:
Amazon Kindle, Google Play book, All peer reviewed journal publishers, self-publishing book publishers, Market research report companies, Research and Development companies, All types of publications. Digital news papers and magazines like Economist, Academic and non academic publishers

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) The invention is a unique business model comprising:

2) users will decide what price they want to pay for the book and other digital publications;

3) the business model of claim 1, where there will contextual advertisement inside the book or paper (usually but not necessarily in the same fraction as the price paid) and give it to the user at the selected price.
